(19) United States
(12) Patent Application Publication
(10) Pub. No.: US 2026/0310860 A1
(43) Pub. Date: Oct. 8, 2026

(54) MACHINE-LEARNING METHODOLIGIES FOR OPTIMIZING A CASING SOLUTION

(71) Applicant: Mars, Incorporated, McLean, VA (US)

(72) Inventors: Carter Hanks ANDERSON, McLean, VA (US); David W. STEFANY, McLean, VA (US)

(21) Appl. No.: 19/479,849

(22) PCT Filed: May 10, 2024
(86) PCT No.: PCT/US2024/028870

§ 371 Date: Oct. 29, 2025

Related U.S. Application Data
(60) Provisional application No. 63/465,987, filed on May 12, 2023.

(51) Int. Cl. G06F 30/27; G06F 113/20

(52) U.S. Cl. CPC G06F 30/27; G06F 2113/20

(57) ABSTRACT

Systems and methods are disclosed for optimizing a solution. The method includes receiving data associated with one or more products and one or more packaging materials from a plurality of data sources. Test data is generated based on the received data. The test data is inputted into a machine-learning model configured to predict packaging requirements and packaging performance. Generating, utilizing the machine-learning model, an optimal packaging configuration based on the prediction. Display the optimal packaging configuration in a user interface of a device.

### CROSS-REFERENCE TO RELATED APPLICATION(S)

This application claims the benefit of priority to U.S. Provisional Application No. 63/465,987, filed on May 12, 2023, the entirety of which is incorporated herein by reference.

### TECHNICAL FIELD

The present disclosure relates generally to the field of data processing and analysis. In particular, the present disclosure relates to machine-learning techniques for predicting packaging requirements and packaging performance.

### BACKGROUND

Conventional methodologies for developing product packaging are technically deficient in terms of effectively integrating chemical and physical data associated with analyzing packaging materials and requirements. This difficulty leads to suboptimal material selections and design decisions, as the methodologies struggle to synthesize and analyze the diverse sets of information effectively. As a result, there is a risk of selecting materials that are incompatible with the packaging, and/or inadequately suited to meet the specific performance criteria of the packaging, ultimately impacting the overall effectiveness and reliability of the packaging. The conventional methods often lack the computational power and analytical capabilities required to navigate the intricate relationship between material properties, product characteristics, and environmental factors. Furthermore, the conventional methods struggle to capture the complex interactions inherent in packaging designs and may overlook critical factors or fail to adequately account for the dynamic nature of packaging requirements. This deficiency hinders their ability to generate comprehensive and precise recommendations.

### SUMMARY OF THE DISCLOSURE

According to aspects of the present disclosure, systems and computer-implemented methods are disclosed for predicting packaging requirements and packaging performance, specifically by analyzing extensive datasets of material properties and packaging specificatoins thorugh machine-learning and data mining algorithms.

In some embodiments, a computer-implemented method includes: receiving, by one or more processors, data associated with one or more objects and one or more casing materials from a plurality of data sources; generating, by the one or more processors, test data based on the received data; inputting, by the one or more processors, the test data into a machine-learning model configured to predict casing requirements and casing performance; generating, by the one or more processors utilizing the machine-learning model, an optimal casing configuration based on the prediction; and causing, by the one or more processors, a display of the optimal casing configuration in a user interface of a device.

In some embodiments, a system includes: one or more processors of a computing system; and at least one non-transitory computer readable medium storing instructions which, when executed by the one or more processors, cause the one or more processors to perform operations including: receiving data associated with one or more objects and one or more casing materials from a plurality of data sources; generating test data based on the received data; inputting the test data into a machine-learning model configured to predict casing requirements and casing performance; generating, utilizing the machine-learning model, an optimal casing configuration based on the prediction; and causing a display of the optimal casing configuration in a user interface of a device.

In some embodiments, a non-transitory computer readable medium storing instructions which, when executed by one or more processors of a computing system, cause the one or more processors to perform operations including: receiving data associated with one or more objects and one or more casing materials from a plurality of data sources; generating test data based on the received data; inputting the test data into a machine-learning model configured to predict casing requirements and casing performance; generating, utilizing the machine-learning model, an optimal casing configuration based on the prediction; and causing a display of the optimal casing configuration in a user interface of a device.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system for predicting packaging requirements and performance, according to aspects of the disclosure.

FIG. 2 is a flowchart of a process for optimizing packaging solutions, according to aspects of the disclosure.

FIG. 3A illustrates a flow diagram of a method for training a machine-learning model to predict packaging structure performance, according to aspects of the disclosure.

FIG. 3B illustrates a graphical flow of an exemplary packaging structure performance model, according to aspects of the disclosure.

FIG. 4A illustrates a flow diagram for training a machine-leaming model to predict packaging requirements, according to aspects of the disclosure.

FIG. 4B illustrates a graphical flow of an exemplary packaging requirement generation model, according to aspects of the disclosure.

FIG. 5 shows an example machine-learning training flow chart.

FIG. 6 illustrates an implementation of a computer system that executes techniques presented herein.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of machine-learning techniques for predicting packaging requirements and packaging performance.

While certain packaging materials may provide protection, sustainability, or aesthetic appeal for particular products, current methodologies fail to effectively discern the compatibility between packaging materials and specific product attributes. This limitation stems from the inability of the traditional approaches to comprehensively evaluate material properties and product characteristics, thereby overlooking critical nuances that influence packaging material suitability. As a consequence, suboptimal packaging is selected, compromising product desirability. In one example, certain packaging materials exhibit varying degrees of suitability for packaging confectionery products due to factors such as moisture resistance, barrier properties, and aesthetic appeal. However, materials like paperboard may be less suitable for direct contact with confectionary products as they may lack the necessary barrier properties to protect against moisture. Therefore, assessing the compatibility between packaging materials and confectionary products requires consideration of specific material properties and product requirements. Addressing this gap requires the integration of advanced computational techniques to enable a more nuanced and accurate assessment of packaging material and product compatibility.

Conventional methodologies also face significant technical challenges when assessing packaging performance due to the time-consuming nature of data collection and analysis processes. The complexity of packaging systems and the multitude of interacting variables necessitate meticulous data collection efforts, resulting in resource-intensive processes that require collection of extensive datasets over various time intervals and prolonged periods, leading to delays in decision-making. Additionally, the disparate nature of data sources and the need for data normalization and integration further exacerbate these challenges, complicating the task of deriving actionable insights and comprehensive performance assessments. There is a pressing need for innovative methodologies, such as machine-learning and data-driven modeling, to streamline the assessment of packaging performance and accelerate the decision-making process.

System 100 leverages advanced computation techniques for predicting packaging requirements with accuracy and efficiency. By utilizing machine-learning algorithms and data mining techniques, the system 100 enables the analysis of extensive datasets encompassing packaging material properties and product characteristics. This comprehensive approach facilitates the identification of optimal packaging materials tailored to specific product attributes, thereby minimizing the risk of material incompatibility and ensuring compliance with performance criteria. By automating and optimizing the analysis process, the system 100 reduces the time and resources required to evaluate packaging performance, overcoming the limitations of traditional approaches. Moreover, by providing comprehensive and accurate performance assessments in real-time, the system 100 identifies potential issues early in the development process, implements corrective measures promptly, and optimizes packaging designs for enhanced reliability and sustainability.

In one instance, the system 100 utilizes machine-learning models to eliminate unlikely material and product combinations to streamline the packaging research and development process. This targeted approach accelerates the packaging research and development process, and minimizes the consumption of materials, time, and manpower traditionally expended on evaluating a multitude of options. In one instance, the system 100 utilizes machine-learning models to provide accurate feasibility estimations and requirements, thereby reducing the need for extensive real-life testing in packaging development. Through sophisticated algorithms and predictive modeling techniques, the system 100 generates a highly accurate estimation of packaging feasibility and requirements.

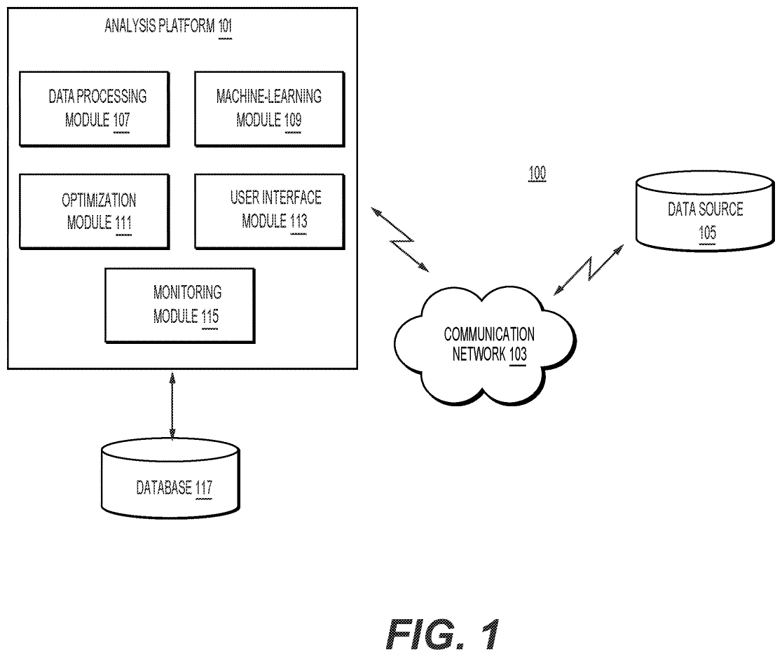

FIG. 1 depicts an example architecture of one or more example embodiments of a networked compuing environment and system 100 that comprises an analysis platform 101, a communication network 103, a data source 105, and database 117. The system 100 introduces a capability to implement modern communication and data processing capabilities into methods and systems for predicting packaging requirements and packaging performance.

In one embodiment, the analysis platform 101 is a platform with multiple interconnected components. The analysis platform 101 includes one or more servers, intelligent networking devices, computing devices, components, and corresponding software that applies machine-learning algorithms for packaging development, optimizing material selection, design configurations, and performance predictions.

In one instance, the analysis platform 101 may utilize machine-learning models for predicting the performance of the packaging material based on its chemical and physical properties. The machine-learning models trained on extensive datasets containing information about material properties, performance metrics, historical project outcomes, and other relevant properties can establish patterns and correlations between material attributes and packaging performance metrics. The analysis platform 101 may accurately predict a packaging material's performance early in the development cycle and reduce the likelihood of investing resources in unsuccessful materials that do not meet performance requirements. The analysis platform 101 may facilitate informed decision-making about material selection, design optimization, and performance enhancement, ultimately leading to the development of more effective, sustainable, and innovative packaging solutions.

In one instance, the analysis platform 101 may utilize machine-learning models for predicting optimal packaging specifications for different products. The analysis platform 101 may identify trends and preferences in packaging design and may tailor requirements to specific market demands and consumer preferences. Accordingly, the analysis platform 101 may provide a data-driven approach for establishing standards and criteria for suppliers, ensuring consistency and quality across packaging materials.

In one instance, the analysis platform 101 may utilize machine-learning models for predicting the success probability of new materials for packaging based on their similarity to previously tested materials and their performance in the previous line and packaging trails. By leveraging historical data from past trials, the analysis platform 101 may analyze the chemical and physical properties of the materials and their corresponding performance metrics to identify patterns and correlations. Through the supervised machine-learning techniques, the analysis platform 101 may recognize the relationships between material properties and the success or failure of the packaging solutions. The analysis platform 101 may predict the likelihood of success for new materials by comparing their properties to those of previously tested materials and assessing their performance in similar packaging trials. By providing a success probability estimate, the analysis platform 101 may prioritize materials with higher success chances, and mitigate risks associated with adopting new materials.

In one instance, the analysis platform 101 may analyze a plurality of datasets (e.g., data source 105) containing information on packaging materials, design configurations, product characteristics, and performance metrics, for identifying key factors that contribute to successful packaging solutions. The analysis platform 101 may utilize this knowledge to predict the optimal packaging properties needed to meet the specific requirements of the new product. The analysis platform 101 may generate tailored packaging designs to the unique needs of each product, ensuring optimal protection, functionality, and consumer appeal. The analysis platform 101 and its components are discussed in detail below.

In one embodiment, various elements of the system 100 may communicate with each other through the communication network 103. The communication network 103 supports a variety of different communication protocols and communication techniques. In one embodiment, the communication network 103 allows the analysis platform 101 to communicate with the data source 105. The communication network 103 of the system 100 includes one or more networks, such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the data source 105 includes internal databases of one or more companies containing (i) historical packaging performance data (e.g., durability, shelf life, barrier properties, and compatibility with different products), (ii) packaging material chemical data (e.g., monomers, polymer chain length, intramolecular interactions/forces, surface energy, fiber length, polarity, composition), (iii) packaging material physical data (e.g., stiffness, coefficient of friction, seal initiation temperature, web strength, barrier properties, repulpability, recyclability), (iv) product characteristics (e.g., product dimensions, weigh, fragility, temperature sensitivity, and storage requirements), and/or (v) packaging requirement data (e.g., product recipe, hot v. cold seal, packaging line machinery, previous trial results). In one embodiment, the data source 105 includes external repositories such as industry databases, scientific literature databases (e.g., extracting valuable insights from peer-reviewed literature for packaging development), and regulatory databases (e.g., packaging regulations, standards, and compliance requirements). In one embodiment, the data source 105 includes supplier databases to access information on the availability, costs, and sustainability credentials of the packaging materials. The analysis platform 101 may access the data source 105 to gather a comprehensive range of data to facilitate the decision-making process and optimize packaging solutions for performance, sustainability, and regulatory compliance.

In one embodiment, the analysis platform 101 includes a data processing module 107, a machine-learning module 109, an optimization module 111, a user interface module 113, a monitoring module 115, or any combination thereof. As used herein, terms such as “component” or “module” generally encompass hardware and/or software, e.g., that a processor or the like is used to implement associated functionality. It is contemplated that the functions of these components are combined in one or more components or performed by other components of equivalent functionality.

In one embodiment, the data processing module 107 may collect relevant data from a plurality of data sources (e.g., the data source 105) through various data collection techniques. The relevant data may include packaging material properties (e.g., density, strength, permeability), product characteristics (e.g., dimensions, weight, fragility), environmental factors (e.g., temperature, humidity), regulatory requirements, performance metrics (e.g., durability, shelf life, recyclability), or a combination thereof. In one example, the data processing module 107 may use a web-crawling component to access the plurality of data sources to collect the relevant data. In another example, the data processing module 107 may include various software applications (e.g., data mining applications in Extensible Markup Language (XML)), that automatically search for and return relevant data. The data processing module 107 may process, parse, and arrange the collected data into a common format that is easily processed by other modules and platforms. In one example, the data processing module 107 may remove or correct erroneous data (e.g., redundant, incomplete, or incorrect data) to create high-quality data to avoid bias and redundancy in the dataset. In one example, the data processing module 107 may categorize the relevant data to assist the machine-learning model in recognizing semantic relationships, enabling the machine-learning model to generate coherent and realistic combinations (e.g., product and packaging combination). By systematically collecting and analyzing these diverse datasets, data processing module 107 facilitates informed decision-making for optimizing packaging solutions.

In one embodiment, the machine-learning module 109 may be trained to analyze complex datasets and make predictions regarding packaging feasibility, requirements, and performance. In one instance, the machine-learning module 109 may receive training data (e.g., training data 512 illustrated in the training flow chart 500) for training a machine-learning model. The machine-learning module 109 may perform model training using training data (e.g., data from other modules) that contains input and correct output, to allow the model to learn over time. The training is performed based on the deviation of a processed result from a documented result when the inputs are fed into the machine-learning model (e.g., an algorithm measures its accuracy through the loss function, adjusting until the error has been sufficiently minimized). In one example, through sophisticated algorithms, such as decision trees, random forests, support vector machines, or neural networks, the machine-learning model learns patterns and relationships within the data to generate predictive models. The predictive models may be utilized to assess the suitability of packaging materials for specific products, predict packaging performance under different conditions, and optimize packaging designs.

In another embodiment, the machine-learning module 109 may randomize the ordering of the training data, visualize the training data to identify relevant relationships between different variables, identify any data imbalances, and split the training data into two parts where one part is for training a model and the other part is for validating the trained model, de-duplicating, normalizing, correcting errors in the training data, and so on. The machine-learning module 109 may implement various machine-learning techniques, e.g., k-nearest neighbors, cox proportional hazards model, decision tree learning, association rule learning, neural network (e.g., recurrent neural networks, graph convolutional neural networks, deep neural networks), inductive programming logic, support vector machines, Bayesian models, etc. In one instance, the machine-learning model may access comprehensive datasets (encompassing material properties, product characteristics, environmental factors, and historical performance data) for creating novel and innovative packaging solutions.

In one embodiment, the optimization module 111 may refine and enhance packaging solutions. In one instance, the optimization module 111 may utilize machine-learning models to evaluate and iterate upon packaging designs to maximize performance, sustainability, and cost-effectiveness. By considering a multitude of factors, such as material properties, product characteristics, environmental considerations, and regulatory requirements, the optimization module identifies optimal configurations and parameters for packaging designs. Through iterative simulations, sensitivity analyses, and design iteration, the optimization module 111 fine-tunes the packaging designs, mitigates risks, and addresses constraints, resulting in a packaging solution that is durable, efficient, and appealing. In one embodiment, the optimization module 111 may utilize predictive analytics capabilities of the machine-learning models for assessing future packaging performance based on anticipated changes in materials, production processes, or environmental conditions. In one example, the optimization module 111 may evaluate the impact of different scenarios and contingencies on packaging performance, allowing for robust decision-making in dynamic and uncertain environments.

In one embodiment, the user interface module 113 may enable a presentation of a graphical user interface (GUI) in a user equipment associated with a user (e.g., a mobile handset, a computer, a tablet, a wireless communication device, a device, etc.), enabling the user to input data, select parameters, and visualize results. The user interface module 113 may employ various application programming interfaces (APIs) or other function calls corresponding to the application on the user equipment, thus enabling the display of graphics primitives such as icons, graphs, menus, buttons, data entry fields, etc. In one example, the user interface module 113 may generate customizable dashboards, data visualization tools, and report generation functionalities, facilitating seamless collaboration. The user interface module 113 may incorporate advanced features, such as real-time updates, scenario modeling, and 3D visualizations, enabling users to explore packaging designs in a dynamic and interactive manner.

In one embodiment, the monitoring module 115 may offer real-time insight into the performance and effectiveness of packaging solutions. In one instance, the monitoring module 115 may continuously monitor key performance indicators, such as packaging durability, shelf life, and environmental impact for tracking the success of package design and identify areas for improvement. In one example, the monitoring module 115 may assess the ability of packaging to maintain product integrity throughout the supply chain, such as product contamination, tampering, and spillage. In one example, the monitoring module 115 may facilitate compliance with regulatory requirements and sustainability goals by tracking adherence to performance standards and regulations. In one example, the monitoring module 115 may gauge customer satisfaction with packaging solutions through feedback mechanisms, surveys, and reviews to ensure that packaging meets consumer expectations.

In one embodiment, the database 117 may store content associated with the analysis platform 101, and manages multiple types of information that provide means for aiding in the content provisioning and sharing process. In one example, the analysis platform 101 may store newly collected data and/or learnings in the database 117 or update the existing knowledge in the database 117 based on the newly collected information. The analysis platform 101 may access, in real-time or near real-time, the database 117 during the analysis process for determining packaging requirements and packaging performance. In one embodiment, the database 117 is any type of database, such as relational, hierarchical, object-oriented, and/or the like, wherein data are organized in any suitable manner, including data tables or lookup tables. In one embodiment, the database 117 includes a machine-learning based training database with a pre-defined mapping defining a relationship between various input parameters and output parameters based on various statistical methods. In one example, the training database includes a dataset that includes data collections that are not subject-specific, e.g., data collections based on population-wide observations, local, regional, or super-regional observations, and the like. The training database is routinely updated and/or supplemented based on machine-learning methods.

The above presented modules and components of the analysis platform 101 are implemented in hardware, firmware, software, or a combination thereof. The various executions presented herein contemplate any and all arrangements and models.

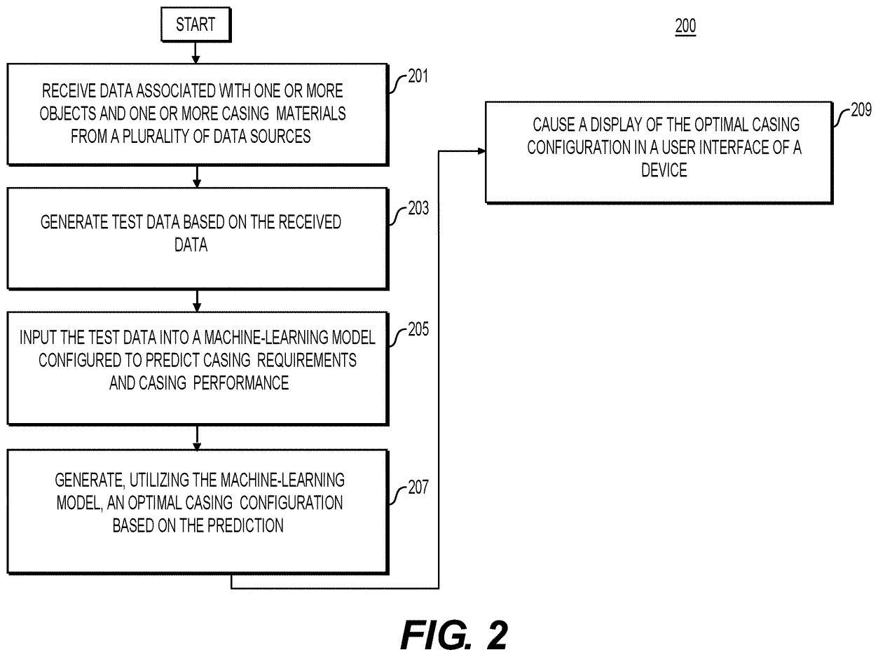

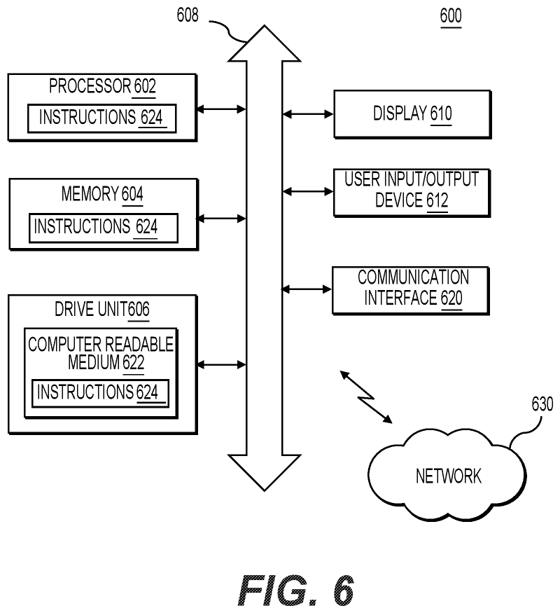

FIG. 2 is a flowchart of a process for optimizing packaging solutions, according to aspects of the disclosure. In various embodiments, the analysis platform 101 and/or any of the modules 107-115 may perform one or more portions of the process 200 and are implemented using, for instance, a chip set including a processor and a memory as shown in FIG. 6. As such, the analysis platform 101 and/or any of modules 107-115 may provide means for accomplishing various parts of the process 200, as well as means for accomplishing embodiments of other processes described herein in conjunction with other components of the system 100. Although the process 200 is illustrated and described as a sequence of steps, it is contemplated that various embodiments of the process 200 may be performed in any order or combination and need not include all of the illustrated steps.

In step 201, the analysis platform 101 may receive data associated with one or more objects (e.g., products that are intended to be packaged) and one or more casing materials (e.g., packaging or packaging materials from a plurality of data sources (e.g., the data source 105). In one example, casing or packaging may include paper packaging, plastic containers, cardboard boxes, bubble wrap, foam packaging, wooden crates, biodegradable packaging, and various other types of packaging. In one example, casing materials (e.g., packaging materials) may include chemical composition specific to each packaging material. For example, foam packaging often crafted from expanded polystyrene (EPS) or polyurethane foam, absorbs shock and vibration. For example, plastic containers fabricated from various polymers like polyethylene terephthalate (PET) of high-density polyethylene (HDPE) ensure durability and resistance to moisture. For example, bubble wraps made from low-density polyethylene (LDPE) offer cushioning properties.

In one instance, the data associated with one or more objects (e.g., products) may include product composition information and product physical attribute information. In one example, the product composition information may include ingredients (e.g., list of all substances used in the product including primary ingredients, additives, preservatives, flavorings, etc.) and/or chemical composition (e.g., chemical composition of each ingredient including chemical names, molecular formulas, concentration levels). In one example, the product's physical attribute information may include dimension (e.g., length, width, and height), weight (e.g., mass or heaviness of the product), shape, fragility (e.g., susceptibility to breakage or damage under impact), and/or temperature sensitivity (e.g., tolerance to temperature changes).

In one instance, the data associated with casing materials (e.g., packaging materials) may include composition information, physical attribute information, barrier properties, thermal properties, and/or sustainability attributes. In one example, the composition information may include chemical properties, compatibility with different product formulations, and/or passing of chemical substances into the products. In one example, the physical attribute information may include density, tensile strength, elongation at break, modulus of elasticity, and/or coefficient of friction. In one example, the barrier properties may include permeability to gases, moisture, and/or light. In one example, the thermal properties may include heat resistance and/or melting point. In one example, the sustainability attributes may include recyclability, repulpability, and/or biodegradability.

In step 203, the analysis platform 101 may generate test data based on the received data. In one instance, the analysis platform 101 may perform a plurality of tests on the received data. In one example, the plurality of tests may include compatibility testing (e.g., measuring compatibility between the product and the packaging materials), physical property testing (e.g., measuring tensile strength, measuring permeability of packaging materials to gases, moisture, and light), seal integrity testing (e.g., assessing the integrity of seals in packaging materials), shelf life testing (e.g., measuring stability and quality of the packaged product over time), and environmental testing (e.g., simulating temperature, humidity, and transportation condition in controlled environments to assess the performance of packaging solutions). The testing methods may be selected based on the specific requirement and performance criteria relevant to the product and packaging materials, ensuring that the testing process accurately evaluates their compatibility and performance.

In one instance, the analysis platform 101 may analyze the test data for evaluating the compatibility and performance of a packaging solution for one or more products. In one example, the analysis platform 101 may utilize statistical techniques to analyze the test data and identify patterns, trends, and correlations. The analysis platform 101 may define performance metrics relevant to the packaging solution's intended use and requirements.

In step 205, the analysis platform 101 may input the test data into a machine-learning model configured to predict casing requirements (e.g., packaging requirements) and casing performance (e.g., packaging performance). In one instance, the analysis platform 101 may train the machine-learning model using supervised learning to establish an association between the test data and performance metrics. In one example, the machine-learning model may compare the test data against the predefined performance metrics, and assess whether the packaging solutions (e.g., casing solutions) meet the performance metrics to identify areas of potential improvement. In one example, the machine-learning model may include a regression model or a classification model.

In one instance, the trained machine-learning model may be optimized through cross-validation techniques. In one example, the dataset is divided into multiple subsets. The machine-learning model is trained on a portion of the data (training set) and validated on another portion (validation set). This process is repeated multiple times, with each subset serving as the validation set exactly once while the remaining sets are used for training. Cross-validation allows for the evaluation of the machine-learning model's performance across different subsets of the data. In one instance, the trained machine-learning model may be iteratively refined based on new test data.

In one instance, the analysis platform 101 may evaluate the performance of the trained machine-learning model. In one example, the analysis platform 101 may compare the trained machine-learning model's predictions to the actual values in a test dataset.

In step 207, the analysis platform 101 may generate, utilizing the machine-learning model, an optimal casing configuration (e.g., packaging configuration) based on the prediction. In one instance, by analyzing predicted outcomes and identifying key factors influencing packaging performance, the analysis platform 101 may determine material selection, design parameters, and optimization strategies. This may include selecting packaging materials with the necessary barrier properties, mechanical strength, and compatibility with the product, as well as optimizing design features such as seal integrity, shelf life, and sustainability attributes. Through iterative refinement and optimization, an optimal packaging configuration is generated that maximizes product protection, and efficiency, while meeting regulatory requirements and sustainability goals.

In step 209, the analysis platform 101 may cause a display of the optimal packaging configuration in the user interface of a device, thereby providing users with a comprehensive overview of the recommended packaging solution. In one example, this display may showcase a visual representation of the product alongside suggested packaging options. The user may interact with the display to explore packaging configurations, viewing a virtual mockup of how the product may be housed within the packaging.

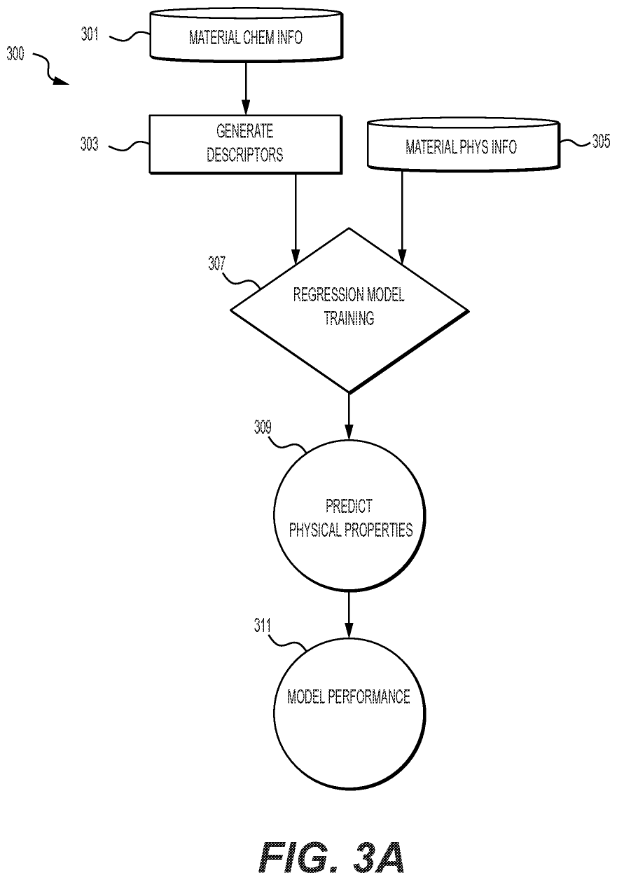

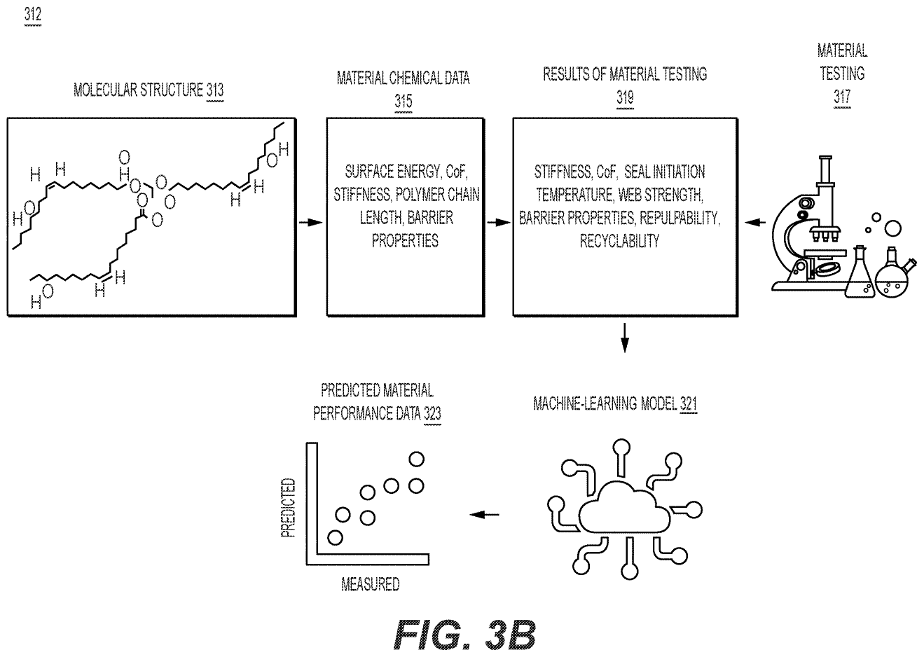

FIG. 3A illustrates a flow diagram of a method for training a machine-learning model to predict packaging structure performance, according to aspects of the disclosure. In various embodiments, the analysis platform 101 and/or any of the modules 107-115 performs one or more portions of the process 300 and are implemented using, for instance, a chip set including a processor and a memory as shown in FIG. 6. In one instance, packaging structure performance indicates the ability of a packaging design to withstand various stresses and strains encountered throughout its lifecycle, including handling, transportation, storage, and use.

In step 301, the analysis platform 101 may collect data on the composition, molecular structure, and chemical properties of packaging materials from a plurality of data sources (e.g., data source 105). In one example, the analysis platform 101 may utilize an application programming interface (API) to access the chemistry development kit (CDK) for extracting chemical predictors, which are essential for analyzing and predicting the behavior of materials. The chemical predictors may be inputted into the machine-learning models for facilitating the development of predictive models for material performance and compatibility in packaging applications.

In step 303, the analysis platform 101 may generate descriptors to represent specific characteristics or features of the materials, providing a standardized way to describe and compare their chemical, physical, or structural properties. In one example, the descriptors may include parameters such as molecular weight, functional groups, and composition data.

In step 305, the analysis platform 101 may obtain the physical properties of the packaging materials to characterize their structural and thermal attributes. In one example, the analysis platform 101 may determine thermal properties such as melting point or thermal conductivity for understanding the material's behavior under different temperature conditions. In one example, the analysis platform 101 may determine structural properties such as density, surface roughness, and opacity, which impact packaging appearance and material compatibility with the packaged product.

In step 307, the analysis platform 101 may input the descriptors and material physical information into a regression model (e.g., machine-learning model). Through regression modeling techniques, the relationships between input descriptors and physical properties are captured and quantified. In one example, the descriptors (e.g., molecular weight, functional groups) along with physical properties (e.g., strength, density, and thermal conductivity) serve as the input variables for the regression model. By training the regression model on a dataset containing labeled examples of materials with known properties, the regression model learns to predict the properties of new materials based on their descriptors and physical information. In one example, Quantitative Structure-Activity Relationship (QSAR) models may include linear regression, stepwise linear regression, partial least squares regression, principal components regression, support vector regression, neural networks, multivariate adaptive regression, multivariate linear regression, or random forest. Other regression model may include Polynomial Regression, Generalized Additive Models, Bayesian Additive Regression Trees (BART), Classification and Regression Tree (CART), Neural Network models including, but not limited to, Multi-Layer Perceptron (MLP), Recurrent Neural Networks (RNN), or Convolutional Neural Networks (CNN).

During regression model training, a standard technique of train/test split is employed for final model evaluation. To optimize model performance, hyperparameters are fine-tuned using x-fold repeated cross-validation, where x typically ranges between 5 and 10. This approach provides a robust estimate of model performance. Furthermore, variable selection techniques, such as recursive feature elimination, backward or forward stepwise selection, simulated annealing, or genetic algorithm search are utilized to identify the most relevant predictors and improve model interpretability and efficiency. By systematically refining model parameters and selecting informative features, regression models can accurately predict packaging properties and requirements.

In step 309, the analysis platform 101 may predict, via the trained regression model, physical properties associated with the packaging (e.g., strength, thermal conductivity, density, etc.) for providing insights into material behavior and performance under different condition.

In step 311, the analysis platform 101 may evaluate the performance of the trained regression model using validation datasets to assess its accuracy and precision.

FIG. 3B illustrates a graphical flow of an exemplary packaging structure performance model, according to aspects of the disclosure. In various embodiments, the analysis platform 101 and/or any of the modules 107-115 performs one or more portions of the process 312 and are implemented using, for instance, a chip set including a processor and a memory as shown in FIG. 6.

In step 313, the analysis platform 101 may characterize the molecular structure of packaging materials, providing insights into their chemical composition and bonding arrangements.

In step 315, the analysis platform 101 may utilize the molecular structure for compiling comprehensive datasets encompassing material chemical data from a plurality of data sources. In one example, material chemical data includes surface energy, coefficient of friction (CoF), stiffness, polymer chain length, and barrier properties, providing insights into the molecular composition and behavior of packaging materials.

In step 317, the analysis platform 101 may conduct material testing to experimentally evaluate the physical attributes of the materials, generating empirical results such as strength, flexibility, and thermal conductivity. In one example, the test results provide insights into the stiffness, CoF, seal initiation temperature, web strength, barrier properties, repulpability, and recyclability of packaging materials.

In step 319, the analysis platform 101 may integrate the test results into the material database, and machine-learning model 321 is employed to analyze the augmented dataset and establish predictive models that correlate molecular structure and material data with performance metrics.

In step 323, the analysis platform 101 may utilize the machine-learning model 321 to predict the performance of packaging materials, enabling informed decision-making in material selection, design optimization, and performance enhancement.

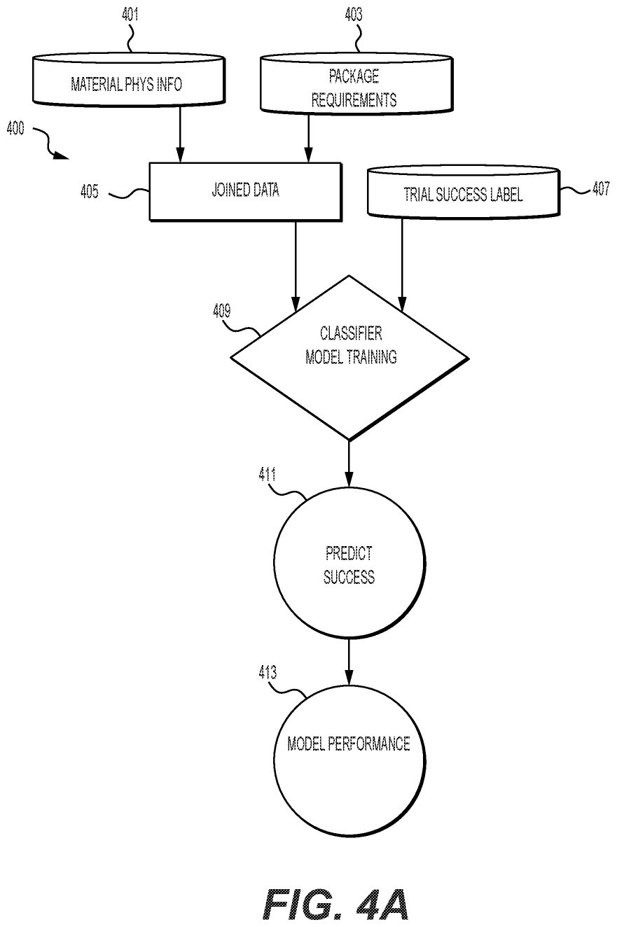

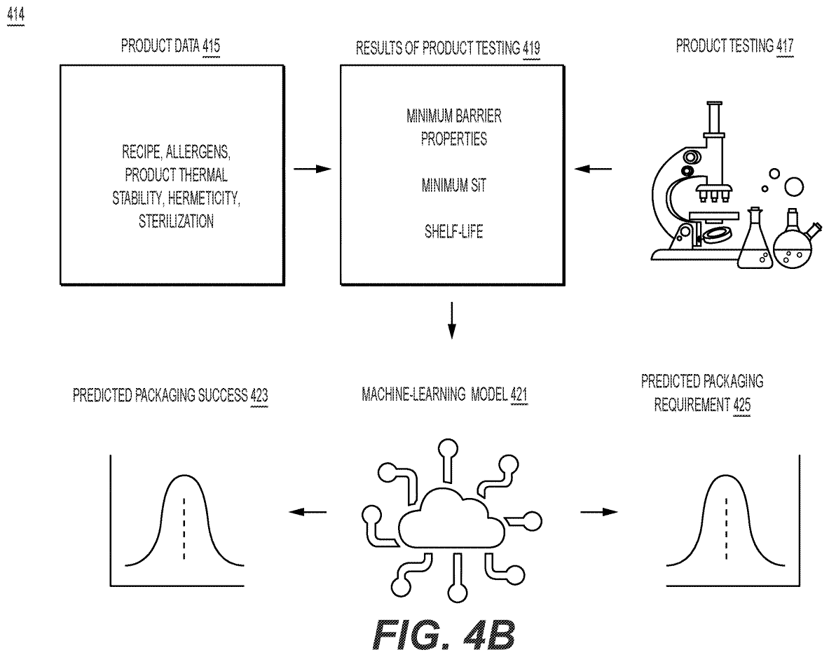

FIG. 4A illustrates a flow diagram for training a machine-learning model to predict packaging requirements, according to aspects of the disclosure. In various embodiments, the analysis platform 101 and/or any of the modules 107-115 performs one or more portions of the process 400 and are implemented using, for instance, a chip set including a processor and a memory as shown in FIG. 6.

In step 401, the analysis platform 101 may access a plurality of data sources (e.g., data source 105) containing data on various attributes of packaging materials. The analysis platform 101 may collect information on material properties, such as density, strength, thermal conductivity, surface roughness, opacity, and barrier properties.

In step 403, the analysis platform 101 may access a plurality of data sources to collect data on specific needs, constraints, and objectives associated with packaging a particular product. The analysis platform 101 may determine the product's characteristics, such as dimension, weight, fragility, and shelf life. The analysis platform 101 may also consider environmental factors, regulatory requirements, and consumer preferences. By analyzing this information, the analysis platform 101 may establish clear specifications and criteria for designing packaging solutions.

In step 405, the analysis platform 101 may integrate the material physical information and the packaging requirements. This fusion of information provides a comprehensive dataset that captures the intricate interplay between material characteristics and packaging performance criteria. By inputting this integrated dataset into a classier model (e.g., a machine-learning model) for training, the analysis platform 101 may identify optimal material package combinations, predict packaging performance outcomes, and optimize design parameters.

In step 407, the analysis platform 101 may access a plurality of data sources to collect trial success labels. In one example, these labels indicate whether a particular packaging design successfully meets predetermined criteria and requirements, such as durability, product protection, and regulatory compliance. By documenting the outcomes of packaging trials, the analysis platform 101 may assess the effectiveness and performance of different packaging solutions.

In step 409, during the process of training a classification model, the analysis platform 101 may input the integrated data set (i.e., material physical information and package requirements) and the trial success label into a classification model (e.g., a machine-learning model). In one example, the classification model is trained on data from the physical properties of the packaging material that is aligned with the requirements. This data is joined as the predictor set and matched to the label of the trial success. The classification model may establish patterns and relationships between the input features and the trial outcomes. By iteratively adjusting model parameters and optimizing performance metrics, the classification model learns to accurately classify trial outcomes based on the input data, distinguishing between successful and unsuccessful trials. In one example, the classification model may include support vector machines, k-nearest neighbors, Bayesian classifiers, or decision trees. Other classification model may include Multinomial Logistic Regression, linear discriminant analysis, quadratic discriminant analysis, random forest, bagged trees, boosted trees such as XGBoost or Gradient Boosting Machines, Neural Network models including, but not limited to, Multi-Layer Perceptron (MLP), Recurrent Neural Networks (RNN), Convolutional Neural Networks (CNN).

During classification model training, a standard technique involves dividing the dataset into training and testing sets for final model evaluation. To optimize model performance, hyperparameters are fine-tuned using x-fold repeated cross-validation, where x typically ranges between 5 and 10. Furthermore, variable selection techniques, such as recursive feature elimination, backward or forward stepwise selection, simulated annealing, or genetic algorithm search are utilized to identify the most relevant features contributing to model performance. Through iterative optimization and evaluation processes, the classification model achieves enhanced predictive accuracy and reliability.

In step 411, the analysis platform 101, via a trained classification model, predicts the likelihood of trial success based on the combined input of material physical properties and package requirements, thereby facilitating informed decision-making in packaging development and optimization efforts.

In step 413, the analysis platform 101 may evaluate the performance of the trained classification model using validation datasets to assess its accuracy and precision. In one example, the performance of the trained classification model may be assessed based on standard classification metrics, such as accuracy, sensitivity, specificity, and scoring thresholds.

FIG. 4B illustrates a graphical flow of an exemplary packaging requirement generation model, according to aspects of the disclosure. In various embodiments, the analysis platform 101 and/or any of the modules 107-115 performs one or more portions of the process 414 and are implemented using, for instance, a chip set including a processor and a memory as shown in FIG. 6.

In step 415, the analysis platform 101 collects product data from a plurality of data sources (e.g., data source 105). In one example, the product data includes information such as a recipe, allergens, product thermal data, product stability, hermeticity, and sterilization.

In step 417, the analysis platform 101 may utilize the collected data as the basis for product testing, where prototypes or samples of the products are subjected to various tests to evaluate factors such as minimum barrier requirements, minimum seal integrity threshold (SIT), and shelf-life (step 419).

The results of these tests (step 419) are fed into the machine-learning model 421 configured for predicting packaging success 423 and packaging requirements 425. The machine-leaning model analyzes the collected data to identify patterns and correlations between product characteristics, testing outcomes, and packaging requirements. By leveraging this predictive model, the analysis platform 101 may generate recommendations regarding packaging selection, design modifications, and optimization strategies.

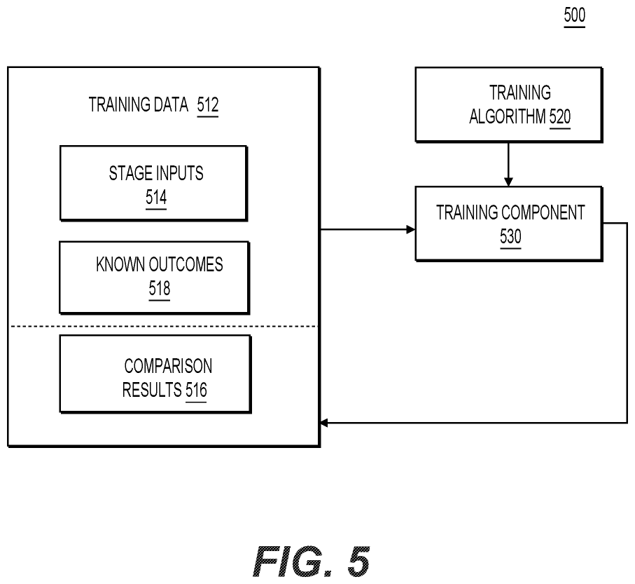

One or more implementations disclosed herein include and/or are implemented using a machine-learning model. For example, one or more of the modules of the analysis platform 101 are implemented using a machine-learning model and/or are used to train the machine-learning model. A given machine-learning model is trained using the training flow chart 500 of FIG. 5. Training data 512 includes one or more of stage inputs 514 and known outcomes 518 related to the machine-learning model to be trained. Stage inputs 514 are from any applicable source including text, visual representations, data, values, comparisons, and stage outputs, e.g., one or more outputs from one or more steps from FIG. 2. The known outcomes 518 are included for the machine-learning models generated based on supervised or semi-supervised training. An unsupervised machine-learning model may not be trained using known outcomes 518. Known outcomes 518 includes known or desired outputs for future inputs similar to or in the same category as stage inputs 514 that do not have corresponding known outputs.

The training data 512 and a training algorithm 520 (e.g., one or more of the ML models implemented using the machine-learning module 109) are used to train the machine-learning model to develop a training component 530 that applies the training algorithm 520 to the training data 512. According to an implementation, the training component 530 is provided comparison results 516 that compare a previous output of the corresponding machine-learning model to apply the previous result to re-train the machine-learning model. The comparison results 516 are used by training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Tree and Random Forest and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the processes illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 6 illustrates an implementation of a computer system that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user network environment, or as a peer computer system in a peer-to-peer (or distributed) network environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. Memory 604 is a main memory, a static memory, or a dynamic memory. Memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. Memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by processor 602 executing the instructions stored in memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. Instructions 624 resides completely or partially within memory 604 and/or within processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 630 communicates voice, video, audio, images, or any other data over network 630. Further, the sets of instructions 624 are transmitted or received over the network 630 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 630, external media, display 610, or any other components in the computer system 600, or combinations thereof. The connection with network 630 is a physical connection, such as a wired Ethernet connection, or is established wirelessly as discussed below. Likewise, the additional connections with other components of the computer system 600 are physical connections or are established wirelessly. Network 630 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to network 630. Network 630 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 630 includes wide area networks (WAN), such as the Internet, local area networks (LAN), campus area networks, metropolitan area networks, a direct connection such as through a Universal Serial Bus (USB) port, or any other networks that allows for data communication. Network 630 is configured to couple one computing device to another computing device to enable communication of data between the devices. Network 630 is generally enabled to employ any form of machine-readable media for communicating information from one device to another. Network 630 includes communication methods by which information travels between computing devices. Network 630 is divided into sub-networks. The sub-networks allow access to all of the other components connected thereto or the sub-networks restrict access between the components. Network 630 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the present disclosure, various features are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed embodiments require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure are practiced without these specific details. In other instances, well-known methods, structures and techniques have not been shown in detail in order not to obscure an understanding of this description.

Thus, while there has been described what are believed to be the preferred embodiments of the present disclosure, those skilled in the art will recognize that other and further modifications are made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method comprising:
receiving, by one or more processors, data associated with one or more objects and one or more casing materials from a plurality of data sources;
generating, by the one or more processors, test data based on the received data;
inputting, by the one or more processors, the test data into a machine-learning model configured to predict casing requirements and casing performance;
generating, by the one or more processors utilizing the machine-learning model, an optimal casing configuration based on the prediction; and
causing, by the one or more processors, a display of the optimal casing configuration in a user interface of a device.

2. The computer-implemented method of claim 1, wherein generating the test data based on the received data comprises:
performing, by the one or more processors, a plurality of tests on the received data, wherein the plurality of tests include one or more of compatibility testing, physical property testing, seal integrity testing, shelf life testing, and environmental testing; and
analyzing, by the one or more processors, the test data for evaluating compatibility and performance of a casing solution for the one or more objects.

3. The computer-implemented method of claim 2, wherein inputting the test data into the machine-learning model configured to predict the casing requirements and the casing performance comprises:
training, by the one or more processors, the machine-learning model using supervised learning for establishing association between the test data and performance metrics;
optimizing, by the one or more processors, the trained machine-learning model through cross-validation techniques; and
evaluating, by the one or more processors, performance of the trained machine-learning model.

4. The computer-implemented method of claim 3, wherein the trained machine-learning model is iteratively refined based on new test data.

5. The computer-implemented method of claim 3, wherein the machine-learning model includes a regression model or a classification model.

6. The computer-implemented method of claim 1, wherein the data associated with the one or more objects include one or more of product composition information and product physical attribute information.

7. The computer-implemented method of claim 6, wherein the product composition information include one or more of ingredients and chemical composition, and wherein the product physical attribute information include one or more of dimension, weight, fragility, and temperature sensitivity.

8. The computer-implemented method of claim 1, wherein the data associated with the one or more casing materials include one or more of composition information, physical attribute information, barrier properties, thermal properties, and sustainability attributes.

9. The computer-implemented method of claim 8, wherein the composition information include one or more of chemical properties, compatibility with different product formulations, and pass chemical substance into the one or more objects, and wherein the physical attribute information include one or more of density, tensile strength, elongation at break, modulus of elasticity, and coefficient of friction.

10. The computer-implemented method of claim 8, wherein the barrier properties include one or more of permeability to gases, moisture, and light, and wherein the thermal properties include one or more of heat resistance and melting point.

11. The computer-implemented method of claim 8, wherein the sustainability attributes include one or more of recyclability, repulpability, and biodegradability.

12. A system comprising:
one or more processors of a computing system; and
at least one non-transitory computer readable medium storing instructions which, when executed by the one or more processors, cause the one or more processors to perform operations comprising:
receiving data associated with one or more objects and one or more casing materials from a plurality of data sources;
generating test data based on the received data;
inputting the test data into a machine-learning model configured to predict casing requirements and casing performance;
generating, utilizing the machine-learning model, an optimal casing configuration based on the prediction; and
causing a display of the optimal casing configuration in a user interface of a device.

13. The system of claim 12, wherein generating the test data based on the received data comprises:
performing a plurality of tests on the received data, wherein the plurality of tests include one or more of compatibility testing, physical property testing, seal integrity testing, shelf life testing, and environmental testing; and
analyzing the test data for evaluating compatibility and performance of a casing solution for the one or more objects.

14. The system of claim 13, wherein inputting the test data into the machine-learning model configured to predict the casing requirements and the casing performance comprises:
training the machine-learning model using supervised learning for establishing association between the test data and performance metrics, wherein the machine-learning model includes a regression model or a classification model;
optimizing the trained machine-learning model through cross-validation techniques, wherein the trained machine-learning model is iteratively refined based on new test data; and
evaluating performance of the trained machine-learning model.

15. The system of claim 12, wherein the data associated with the one or more objects include one or more of product composition information and product physical attribute information.

16. The system of claim 15, wherein the product composition information include one or more of ingredients and chemical composition, and wherein the product physical attribute information include one or more of dimension, weight, fragility, and temperature sensitivity.

17. The system of claim 12, wherein the data associated with the one or more casing materials include one or more of composition information, physical attribute information, barrier properties, thermal properties, and sustainability attributes.

18. A non-transitory computer readable medium, the non-transitory computer readable medium storing instructions which, when executed by one or more processors of a computing system, cause the one or more processors to perform operations comprising:
receiving data associated with one or more objects and one or more casing materials from a plurality of data sources;
generating test data based on the received data;
inputting the test data into a machine-learning model configured to predict casing requirements and casing performance;
generating, utilizing the machine-learning model, an optimal casing configuration based on the prediction; and
causing a display of the optimal casing configuration in a user interface of a device.

19. The non-transitory computer readable medium of claim 18, wherein generating the test data based on the received data comprises:
performing a plurality of tests on the received data, wherein the plurality of tests include one or more of compatibility testing, physical property testing, seal integrity testing, shelf life testing, and environmental testing; and
analyzing the test data for evaluating compatibility and performance of a casing solution for the one or more objects.

20. The non-transitory computer readable medium of claim 19, wherein inputting the test data into the machine-learning model configured to predict the casing requirements and the casing performance comprises:
training the machine-learning model using supervised learning for establishing association between the test data and performance metrics;
optimizing the trained machine-learning model through cross-validation techniques; and
evaluating performance of the trained machine-learning model.
